(19) United States
(12) Patent Application Publication
(10) Pub. No.: US 2025/0225969 A1
(43) Pub. Date: Jul. 10, 2025

(54) ACTIVE NOISE REDUCTION MICROPHONE CIRCUIT STRUCTURE AND ACTIVE NOISE REDUCTION MICROPHONE

(71) Applicant: Dongguan Feng Lun Electronic Technology Co., Ltd., Dongguan City (CN)

(72) Inventors: Jing-Luen Wen, Dongguan City (CN); Hsin-Hao Wen, Dongguan City (CN)

(21) Appl. No.: 18/673,270

(22) Filed: May 23, 2024

(30) Foreign Application Priority Data
Jan. 5, 2024 (CN) 202420038539.5
Jan. 5, 2024 (CN) 202420038887.2

(51) Int. Cl. G10K 11/178; H04R 1/08; H04R 3/00

(52) U.S. Cl. CPC G10K 11/178; H04R 1/086; H04R 3/007; G10K 2210/1082; H04R 2420/09

(57) ABSTRACT

An active noise reduction microphone circuit structure and an active noise reduction microphone are disclosed. The active noise reduction microphone includes a clamp, a retaining seat, an active noise reduction control board, an outer tube, and an electret condenser microphone. The active noise reduction microphone can be installed and secured to an external object quickly through the clamp. The outer tube and a sound-collecting tube are used for sound collection. By providing a preamplifier circuit, an ADC circuit and a DSP circuit, the active noise reduction microphone has an active noise reduction function and can be used conveniently.

### BACKGROUND OF THE INVENTION

### 1. Field of the Invention

The present invention relates to a microphone, and more particularly to an active noise reduction microphone circuit structure and an active noise reduction microphone.

### 2. Description of the Prior Art

A microphone is a device used for collecting the sound of the live environment and transmit it to a back-end device. The microphone is composed of a housing, an electret condenser microphone, and an audio amplifier circuit. In practice, the use of microphones is highly purposeful. In other words, whether the technical indicators or characteristics of a microphone are ideal depends on the purpose for which it is to be used in a given environment. Nonetheless, each microphone has basic design characteristics and technical indicators. Commonly used technical indicators include sensitivity, frequency response, equivalent sound pressure level, directivity, dynamic range, maximum sound pressure level and output impedance, etc. The directivity of a microphone, also known as the directionality of a microphone, refers to the response of the microphone to sound pressure at different angles of incidence. Specifically, when sound waves are incident on the diaphragm of a microphone at different angles, the diaphragm is subjected to different forces, and therefore the corresponding output is different. This property, which varies the sensitivity of a microphone depending on the angle of the incident sound wave, is called the directivity of the microphone.

A conventional microphone lacks a mounting structure used for connecting an external object, so it cannot be installed and secured to the external object quickly. Besides, the conventional microphone does not have an active noise reduction function and needs to be connected to an external device for noise reduction processing. It is inconvenient to use the microphone. Accordingly, the inventor of the present invention has devoted himself based on his many years of practical experiences to solve these problems.

### SUMMARY OF THE INVENTION

In view of the shortcomings of the prior art, the primary object of the present invention is to provide an active noise reduction microphone circuit structure and an active noise reduction microphone, which can solve the problem that the conventional microphone cannot be installed and secured to an external object quickly and does not have an active noise reduction function.

In order to achieve the above object, the present invention adopts the following technical solutions:

An active noise reduction microphone circuit structure comprises a preamplifier circuit, an ADC (analog-to-digital conversion) circuit, and a DSP (digital signal processing) circuit. The ADC circuit is connected to the preamplifier circuit. The DSP circuit is connected to the ADC circuit.

Preferably, the active noise reduction microphone circuit structure further comprises a USB (universal serial bus) interface. The USB interface is connected to the DSP circuit.

Preferably, the active noise reduction microphone circuit structure further comprises an OVP (over voltage protection) circuit. The OVP circuit is connected to the USB interface.

Preferably, the active noise reduction microphone circuit structure further comprises an LDO (low dropout) circuit and a FLASH circuit. The LDO circuit is connected to the DSP circuit, the ADC circuit and the FLASH circuit.

Preferably, the active noise reduction microphone circuit structure further comprises a DC-DC (direct current) circuit. The DC-DC circuit is connected to the DSP circuit and the peripheral related circuits for supplying power.

An active noise reduction microphone comprises a clamp, a retaining seat, an active noise reduction control board, an outer tube, and an electret condenser microphone. The retaining seat is disposed on the clamp. The active noise reduction control board is disposed in the retaining seat. The active noise reduction control board has the foregoing active noise reduction microphone circuit structure. The outer tube is disposed on the retaining seat and extends in a front-to-rear direction. The outer tube has an accommodation chamber therein. A front end face of the outer tube has a through hole communicating with the accommodation chamber. An outside of the outer tube has a plurality of slots. The plurality of slots is arranged at intervals in the front-to-rear direction and all communicate with the accommodation chamber. The electret condenser microphone is disposed in the accommodation chamber. The electret condenser microphone is electrically connected to the preamplifier circuit. The electret condenser microphone has a sound-collecting tube. The sound-collecting tube extends in the front-to-rear direction and is disposed in the accommodation chamber. The sound-collecting tube has a plurality of sound holes. The plurality of sound holes face the corresponding slots, respectively.

Preferably, the clamp includes a clamp body, a movable seat, and a bracket. The movable seat is disposed on the clamp body and is movable upward and downward. The bracket is disposed on the movable seat. The retaining seat is mounted on the bracket.

Preferably, the bracket is C-shaped and has a locking groove thereon. The retaining seat is connected to the locking groove in a snap-fit manner.

Preferably, a sponge sleeve is fitted on the outer tube.

Compared with the prior art, the present invention has obvious advantages and beneficial effects. Specifically, it can be known from the above technical solutions:

The product of the present invention can be installed and secured to an external object quickly through the clamp. The present invention has the outer tube and the active noise reduction control board. The outer tube and the sound-collecting tube are used for sound collection. The present invention further has the preamplifier circuit, the ADC circuit and the DSP circuit. The audio signal is picked up by the electret condenser microphone, and passes through the preamplifier circuit for preamplification, and then pass through ADC circuit for analog-to-digital conversion into an IIS digital signal. The IIS digital signal is output to the chip of the DSP circuit for noise reduction processing, thereby realizing the active noise reduction function. There is no need to connect an external device, making it easier to use.

Embodiments of the present invention will now be described, by way of example only, with reference to the accompanying drawings.

### BRIEF DESCRIPTION OF THE DRAWINGS

FIG. 1 is a perspective view according to a preferred embodiment of the present invention;

FIG. 2 is another perspective view according to the preferred embodiment of the present invention;

FIG. 3 is a partial exploded view according to the preferred embodiment of the present invention;

FIG. 4 is a cross-sectional view according to the preferred embodiment of the present invention;

FIG. 5 is a circuit block diagram according to the preferred embodiment of the present invention;

FIG. 6 is a first partial schematic view of the circuit structure according to the preferred embodiment of the present invention;

FIG. 7 is a second partial schematic view of the circuit structure according to the preferred embodiment of the present invention; and

FIG. 8 is a third partial schematic view of the circuit structure according to the preferred embodiment of the present invention.

### DETAILED DESCRIPTION OF THE PREFERRED EMBODIMENTS

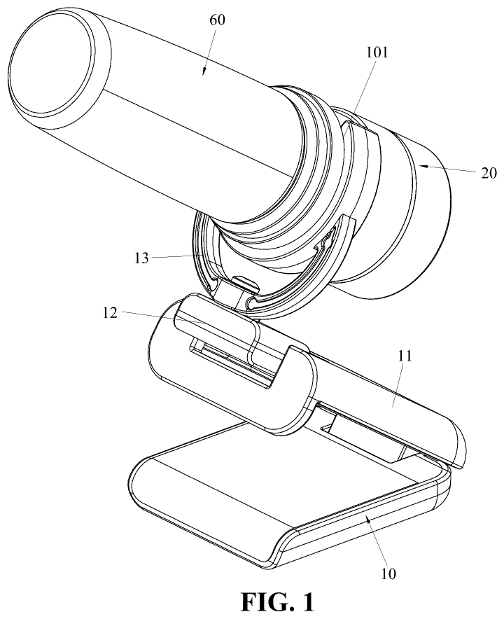

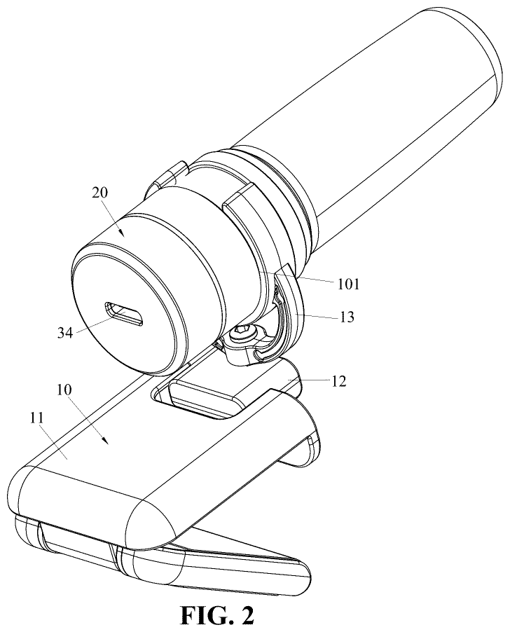

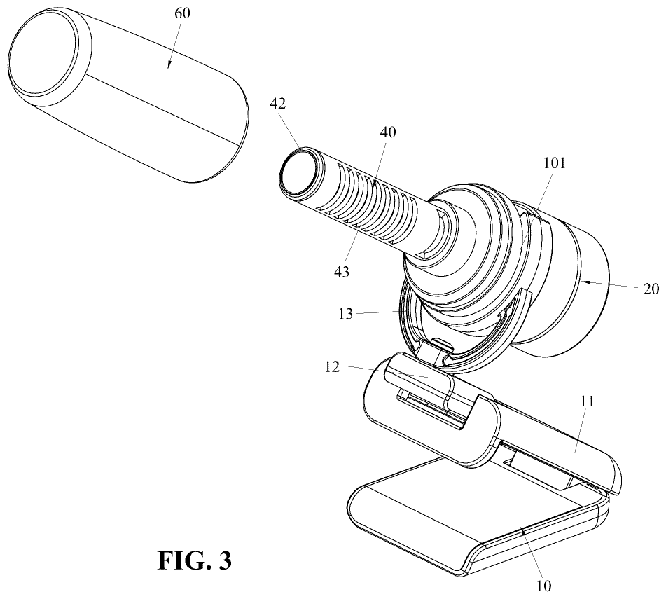

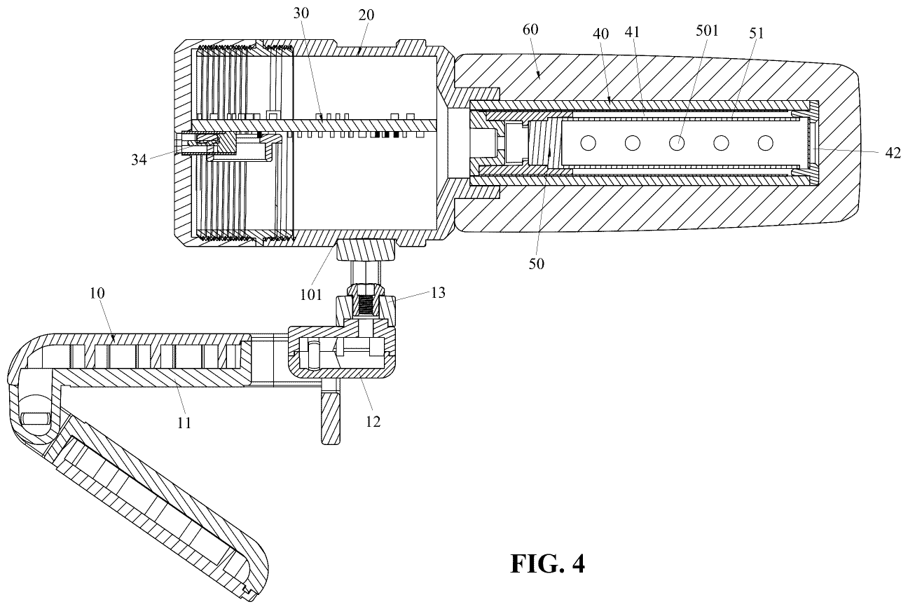

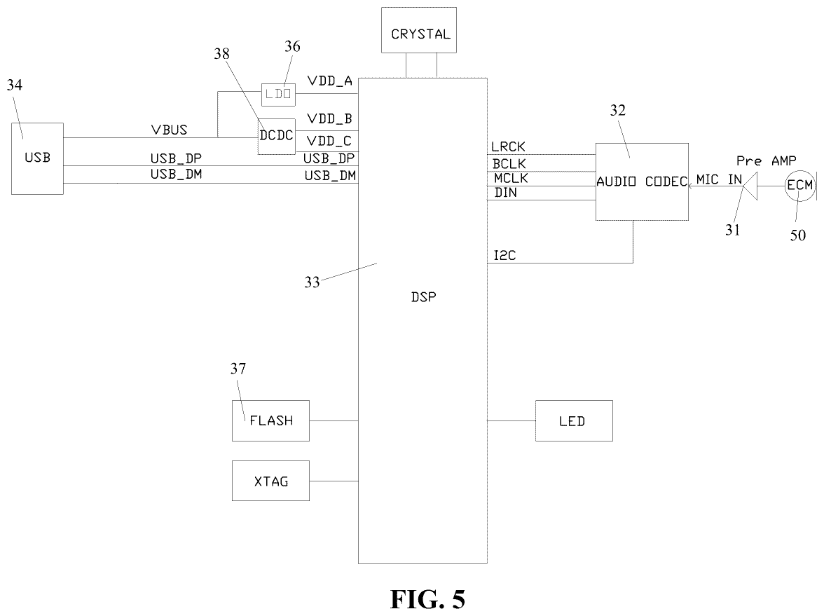

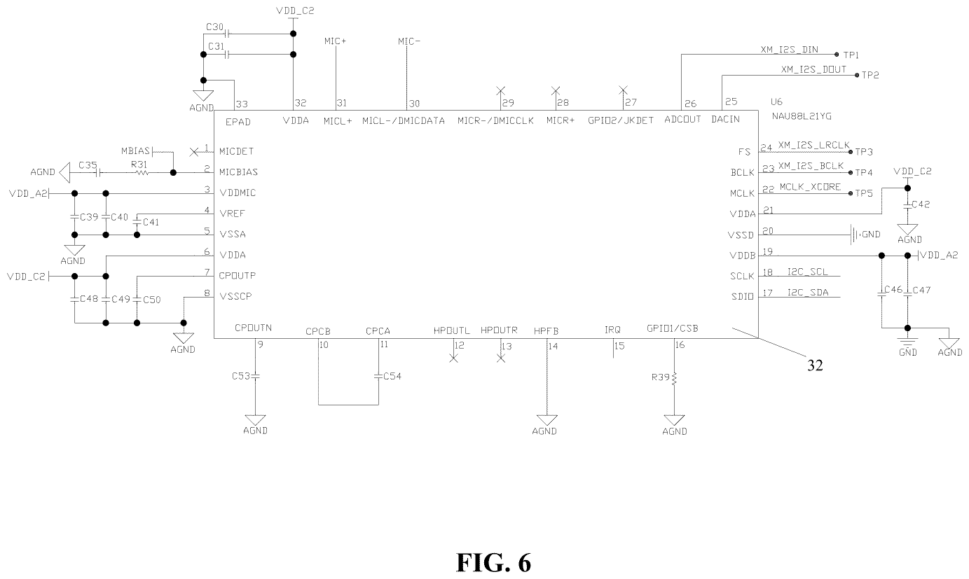

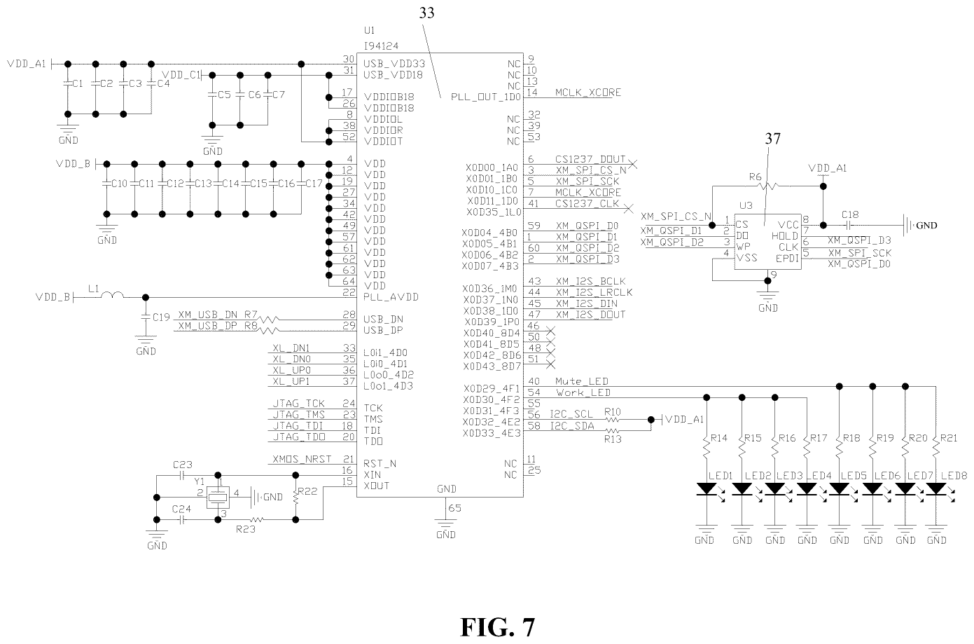

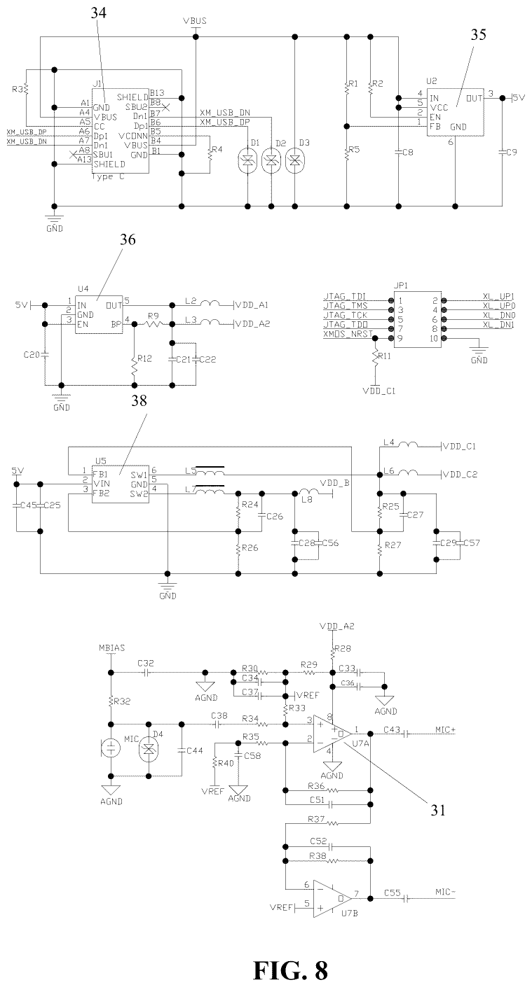

FIGS. 1 to 15 show the specific structure of a preferred embodiment of the present invention, comprising a clamp 10, a retaining seat 20, an active noise reduction control board 30, an outer tube 40 and an electret condenser microphone 50.

The clamp 10 includes a clamp body 11, a movable seat 12, and a bracket 13. The clamp body 11 is configured for clamping an external object. The movable seat 12 is disposed on the clamp body 11 and is movable upward and downward. The bracket 13 is disposed on the movable seat 12. The bracket 13 is C-shaped and has a locking groove 101 thereon.

The retaining seat 20 is disposed on the clamp 10. In this embodiment, the retaining seat 20 is mounted on the bracket 13 so that the retaining seat 20 can be moved upward and downward. The retaining seat 20 is connected to the locking groove 101 in a snap-fit manner, which is simple in structure and easy to disassemble and assemble.

The active noise reduction control board 30 is disposed in the retaining seat 20. The active noise reduction control board 30 has an active noise reduction microphone circuit structure thereon. The active noise reduction microphone circuit structure includes a preamplifier circuit 31, an ADC (analog-to-digital conversion) circuit 32, and a DSP (digital signal processing) circuit 33. The ADC circuit 32 is connected to the preamplifier circuit 31. The DSP circuit 33 is connected to the ADC circuit 32. In this embodiment, the active noise reduction control board 30 further has a USB (universal serial bus) interface 34. The USB interface 34 is connected to the DSP circuit 33, so as to transmit signals to an external PC through a USB connection cable. The active noise reduction control board 30 further has an OVP (over voltage protection) circuit 35. The OVP circuit 35 is connected to the USB interface 34 to prevent damage to the USB interface 34 because of excessive voltage. The active noise reduction control board 30 further has an LDO (low dropout) circuit 36 and a FLASH circuit 37. The LDO circuit 36 is connected to the DSP circuit 33, the ADC circuit 32 and the FLASH circuit 37 to supply power with a certain voltage for the operations of the DSP circuit 33, the ADC circuit 32, and the FLASH circuit 37. The active noise reduction control board 30 further has a DC-DC (direct current) circuit 38. The DC-DC circuit 38 is connected to the DSP circuit 33 and the peripheral related circuits to output two sets of power supplies with a certain voltage for the operations of the DSP circuit 33 and the peripheral related circuits.

The outer tube 40 is disposed on the retaining seat 20 and extends in a front-to-rear direction. The outer tube 40 has an accommodation chamber 41 therein. The front end face of the outer tube 40 has a through hole 42 communicating with the accommodation chamber 41. The outside of the outer tube 40 has a plurality of slots 43. The plurality of slots 43 are arranged at intervals in the front-to-rear direction and all communicates with the accommodation chamber 41. In this embodiment, each slot 43 is arc-shaped. The slots 43 are in two rows arranged radially, symmetrically on the left and right.

The electret condenser microphone 50 is disposed in the accommodation chamber 41. The electret condenser microphone 50 is electrically connected to the active noise reduction control board 30. The electret condenser microphone 50 has a sound-collecting tube 51. The sound-collecting tube 51 extends in the front-to-rear direction and is disposed in the accommodation chamber 41. The sound-collecting tube 51 has a plurality of sound holes 501. The plurality of sound holes 501 face the corresponding slots 43, respectively. In this embodiment, the preamplifier circuit 31 is electrically connected to the electret condenser microphone 50.

A sponge sleeve 60 is fitted on the outer tube 40 to prevent impact sounds.

The working principle of this embodiment is described in detail as follows:

When in use, the product of the present invention is secured to an external object, such as a screen, through the clamp, and a cable is used to connect a PC and the USB interface 34. In operation, the audio signal is picked up by the electret condenser microphone 50 to pass through the capacitor C38, the resistor R34 and the operational amplifier U7A of the preamplifier circuit 31 for preamplification, and then pass through the capacitor C43, the capacitor C55 and the ADC circuit 32 for analog-to-digital conversion into an IIS digital signal. The IIS digital signal is output to the chip U1 of the DSP circuit 33 for noise reduction processing, and is sent to the PC via the USB interface 34 after the processing is completed.

The feature of the present invention is that the product can be quickly installed and secured to an external object through the clamp. The present invention has the outer tube and the active noise reduction control board. The outer tube and the sound-collecting tube are used for sound collection. The present invention further has the preamplifier circuit, the ADC circuit and the DSP circuit. The audio signal is picked up by the electret condenser microphone, and passes through the preamplifier circuit for preamplification, and then pass through ADC circuit for analog-to-digital conversion into an IIS digital signal. The IIS digital signal is output to the chip of the DSP circuit for noise reduction processing, thereby realizing the active noise reduction function. There is no need to connect an external device, making it easier to use.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An active noise reduction microphone circuit structure, comprising a preamplifier circuit, an ADC (analog-to-digital conversion) circuit, and a DSP (digital signal processing) circuit; the ADC circuit being connected to the preamplifier circuit, the DSP circuit being connected to the ADC circuit.

2. The active noise reduction microphone circuit structure as claimed in claim 1, further comprising a USB (universal serial bus) interface, the USB interface being connected to the DSP circuit.

3. The active noise reduction microphone circuit structure as claimed in claim 2, further comprising an OVP (over voltage protection) circuit, the OVP circuit being connected to the USB interface.

4. The active noise reduction microphone circuit structure as claimed in claim 1, further comprising an LDO (low dropout) circuit and a FLASH circuit, the LDO circuit being connected to the DSP circuit, the ADC circuit and the FLASH circuit.

5. The active noise reduction microphone circuit structure as claimed in claim 1, further comprising a DC-DC (direct current) circuit, the DC-DC circuit being connected to the DSP circuit.

6. An active noise reduction microphone, comprising a clamp, a retaining seat, an active noise reduction control board, an outer tube, and an electret condenser microphone; the retaining seat being disposed on the clamp; the active noise reduction control board being disposed in the retaining seat, the active noise reduction control board having the active noise reduction microphone circuit structure as claimed in claim 1; the outer tube being disposed on the retaining seat and extending in a front-to-rear direction, the outer tube having an accommodation chamber therein, a front end face of the outer tube having a through hole communicating with the accommodation chamber, an outside of the outer tube having a plurality of slots, the plurality of slots being arranged at intervals in the front-to-rear direction and communicating with the accommodation chamber; the electret condenser microphone being disposed in the accommodation chamber, the electret condenser microphone being electrically connected to the preamplifier circuit, the electret condenser microphone having a sound-collecting tube, the sound-collecting tube extending in the front-to-rear direction and being disposed in the accommodation chamber, the sound-collecting tube having a plurality of sound holes, the plurality of sound holes facing the corresponding slots, respectively.

7. The active noise reduction microphone as claimed in claim 6, wherein the clamp includes a clamp body, a movable seat, and a bracket; the movable seat is disposed on the clamp body and is movable upward and downward, the bracket is disposed on the movable seat, and the retaining seat is mounted on the bracket.

8. The active noise reduction microphone as claimed in claim 7, wherein the bracket is C-shaped and has a locking groove thereon, and the retaining seat is connected to the locking groove in a snap-fit manner.

9. The active noise reduction microphone as claimed in claim 6, wherein a sponge sleeve is fitted on the outer tube.
